(19) United States
(12) Patent Application Publication
(10) Pub. No.: US 2026/0352039 A1
(43) Pub. Date: Nov. 5, 2026

(54) ROTOR

(71) Applicant: SIEMENS AKTIENGESELLSCHAFT, München (DE)

(72) Inventors: Reiner SEUFERT, Bad Neustadt a.d . Saale (DE); ROLF VOLLMER, Bad Neustadt a.d . Saale (DE)

(73) Assignee: SIEMENS AKTIENGESELLSCHAFT, 80333 München (DE)

(21) Appl. No.: 19/488,729

(22) PCT Filed: Jan. 29, 2024
(86) PCT No.: PCT/EP2024/052043

§ 371 Date: Nov. 28, 2025

(30) Foreign Application Priority Data
May 31, 2023 (EP) 23176377.2

(51) Int. Cl. H02K 1/02; H01F 1/057; H02K 1/278; H02K 15/035

(52) U.S. Cl. CPC H02K 1/02; H01F 1/057; H02K 1/278; H02K 15/035

(57) ABSTRACT

A rotor for a dynamoelectric rotary machine includes an iron-free support body including ceramic and/or aluminum and/or carbon fiber-reinforced plastic, and a plurality of magnets arranged on and/or at least partially within the support body. The magnets have a lens-shaped configuration and are magnetized laterally so that magnetization directions run such that one pole of the rotor is formed by poles of a same polarity of two adjacent ones of the magnets. The magnets have rare earth material cerium, neodymium, iron (Fe) and boron (B) and are composed stoichiometrically according to R₂Fe₁₄B, wherein R has the elements neodymium (Nd), praseodymium (Pr), cerium (Ce), lanthanum (La) and/or yttrium (Y), and wherein cerium is at least 50% of R.

The invention relates to a rotor for a dynamoelectric rotary machine.

Permanently excited synchronous machines typically have NdFeB magnets. Manufacture of these magnets is energy-intensive, however. Moreover, focusing on one material entails the risk that this is no longer available or its price increases. If other magnets are used, the dynamic response of the machine usually suffers.

The object underlying the invention is to provide a highly dynamic machine while taking into account the magnet problem.

The object is achieved by claim 1, i.e. a rotor for a dynamoelectric rotary machine, having a support body and a plurality of magnets, wherein the magnets are arranged on and/or at least partially within the support body, wherein the magnets are lens-shaped, wherein the magnets have rare earth material, wherein at least 50% of the rare earth material is cerium.

The magnets are advantageously biconvex lens-shaped and/or plano-convex lens-shaped and/or concave-convex lens-shaped.

The magnets are preferably magnetized laterally.

This is advantageously achieved in that a magnetization takes place in the magnet from one side or surface.

With a lens-shaped magnet, the poles are preferably on the surface which is facing the rotor.

These magnets, in particular permanent magnets, are advantageously magnetized laterally, i.e. in this respect it is possible to imagine a bar magnet, the ends of which, in other words the poles, are facing one another, are in particular almost folded together or even are folded together. Basically, a magnetic pole north or south of the rotor is therefore formed advantageously by two adjacent poles of the same name, north-north or south-south, of the permanent magnet. This is already described in more detail in EP 2991195A1.

A pole of the rotor is advantageously formed by the pole, of the same name, of two magnets adjacent to one another.

The support body is preferably iron-free.

By avoiding soft-magnetic materials in the rotor, the inductances of the motor are reduced, for instance. The current can therefore be impressed more rapidly into the motor winding, which in turn increases the dynamic response of the motor.

One embodiment is advantageous, according to which the support body has ceramic, in particular technical ceramic and/or aluminum and/or carbon fiber-reinforced plastic.

In particular, lens magnets magnetized laterally permit a non-magnetic carrier material, such as for instance technical ceramic, aluminum or carbon fiber-reinforced plastic (CRP for short). This produces many advantages, e.g. a lower weight, a lower moment of inertia and a higher rigidity. This advantageously results in an increased motor dynamic response and a lower tendency to vibrate.

One embodiment is advantageous, according to which the magnets have cerium.

As an element, cerium (Ce) is used more frequently than the previously used rare earth neodymium (Nd) and is available extensively in mining areas. Cerium has a good ecobalance and is cheap.

In most cases rare earths such as neodymium, and particularly the heavy rare earths such as e.g. dysprosium and terbium, which are sometimes also contained as alloy elements in the permanent magnets described, originate from Asia.

Cerium is available worldwide and therefore contributes to the diversification of supply chains. A security of supply is therefore increased.

The magnets can also have an alloy, having cerium, neodymium, iron and boron.

The magnets have, as already mentioned above, rare earth material, wherein at least 50% of one rare earth material is cerium.

A dynamic machine can thus be created, which is also cheap.

The magnets are preferably composed stoichiometrically like R₂Fe₁₄B. Here R is advantageously composed of the elements neodymium (Nd), praseodymium (Pr), cerium (Ce), lanthanum (La), yttrium (Y) and/or other trace elements.

Here cerium preferably accounts for at least 50% of R. Particularly advantageously, in particular with regard to environmental aspects, magnets have neodymium, iron and/or boron obtained from recycling material.

In a further advantageous embodiment, the magnets have a shape deviation on the air gap side.

This shape deviation is advantageously embodied as a linear depression with a rounded and/or flat base.

The shape deviation is advantageously embodied as a corrugation and/or groove.

The shape deviation is advantageously embodied circumferentially on an outer periphery of the rotor.

This is advantageous in that a binding, in particular arranged on the outer periphery of the rotor, holds well and slippage is not an issue.

The binding process is also facilitated during a manufacturing method.

The binding is advantageously a thread binding, wherein a binding thread is arranged in depressions of the shape deviation.

The object is further achieved by a dynamoelectric machine having a rotor of this type.

The object is also achieved by a method for manufacturing a magnet having cerium for a rotor of this type, wherein the magnet is manufactured by means of metal injection molding (MIM for short).

The MIM method is a metal powder injection molding method and is known from the prior art.

A shape deviation or a structure is advantageously embodied on at least one side of the magnet.

A linear depression, in particular grooves and/or corrugations, is advantageously embodied.

With the aid of the MIM method, a structured surface can be produced particularly easily, in particular on the side of the magnets facing the air gap, which can be used in particular for binding with binding threads.

By means of a binding, a smaller magnetic air gap is possible, which results in higher torques and a higher motor dynamic response.

The invention is described and explained in more detail It is shown in:

FIG. 1 a unit having a support body and a plurality of magnets,

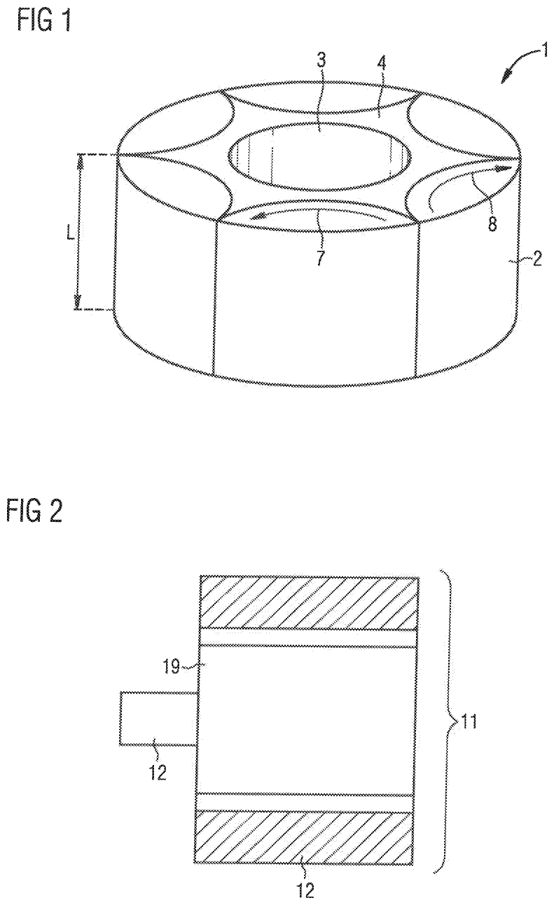

FIG. 2 a dynamoelectric rotary machine,

FIG. 3 a rotor,

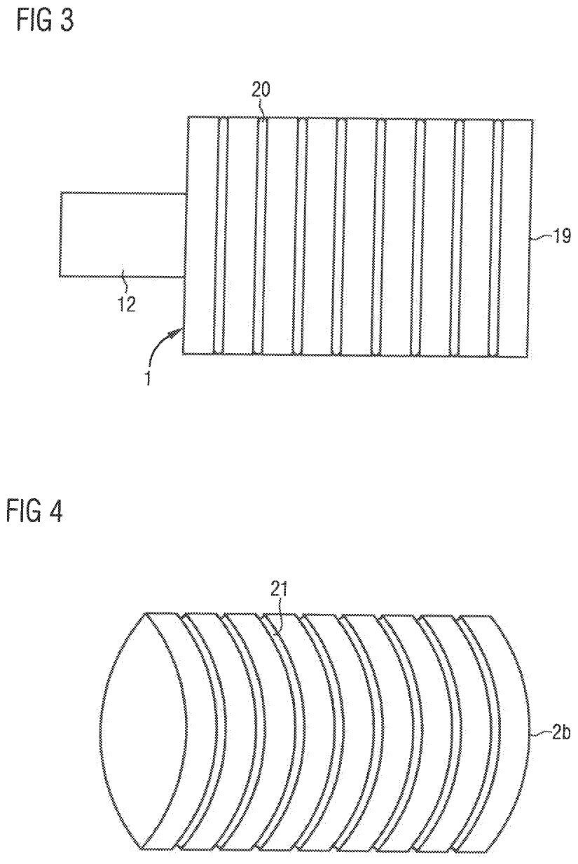

FIG. 4 a magnet,

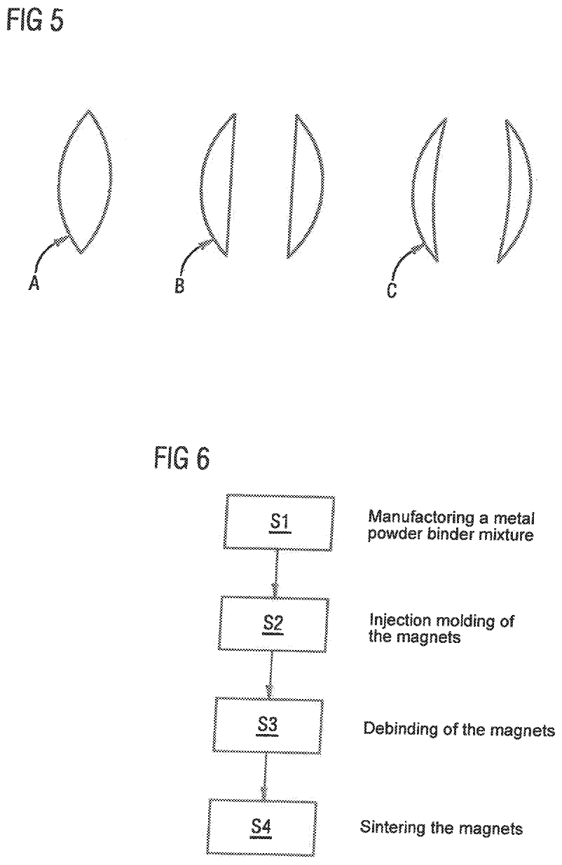

FIG. 5 possible lens shapes

FIG. 6 an exemplary manufacturing method.

FIG. 1 shows a unit 1 having a support body 4, which supports a plurality of magnets 2, and a corrugated cutout 3 for a rotor 19, see FIG. 2.

The support structure is advantageously iron-free.

In the figure the magnets 2 are biconvex lens-shaped. Other lens shapes can also be used.

The lens shapes shown in FIG. 5 are particularly advantageous here: A: biconvex lens-shaped, B: planoconvex lens-shaped, C: concave-convex lens-shaped. Others are also possible.

The two bulges of the biconvex lens-shaped magnet 2 may be identical. It is also possible that the radi of the opposing bulges are different.

The figure moreover shows an axial extension of the unit 1 or a length L.

The magnets 2 are advantageously magnetized laterally. This is Identified by the magnetization directions 7 and 8.

FIG. 2 shows a dynamoelectric rotary machine 11, having a stator 10 and the rotor 19 with a shaft 12.

FIG. 3 shows the rotor 19 having a thread binding. The binding thread 20 is advantageously disposed in the grooves or corrugations 21, which have a magnet 2b, see FIG. 4, for instance.

However, the binding can also be applied when the magnet has no structure or no shape deviation.

FIG. 6 shows an exemplary manufacturing method. A magnet 2, 2b, having cerium, for a rotor 19, is manufactured here by means of metal injection molding.

In a method step S1, a feedstock production takes place, in other words in particular the manufacture of a metal powder-binder mixture. This advantageously has cerium in powder form.

Further materials may also be included, in particular neodymium, iron and/or boron.

In a method step S2, injection molding takes place. A shape deviation or structure is advantageously embodied on at least one side of the magnet.

In a method step S3, a debinding takes place.

In a method step S4, a sintering of the magnet takes place.

The method is advantageous since only a small amount of energy is required.

A dynamic, permanently-excited synchronous machine can be manufactured by means of the invention. The advantageously iron-free support body 4 and the reduced energy requirement during magnet production address the environmental aspect in particular. When recycling material is used for the feedstock production, the manufacturing process is particularly sustainable.

1.-16. (canceled)

17. A rotor for a dynamoelectric rotary machine, the rotor comprising:
an iron-free support body including ceramic and/or aluminum and/or carbon fiber-reinforced plastic; and
a plurality of magnets arranged on and/or at least partially within the support body, said magnets having a lens-shaped configuration and being magnetized laterally so that magnetization directions run such that one pole of the rotor is formed by poles of a same polarity of two adjacent ones of the magnets, said magnets including rare earth material cerium, neodymium, iron (Fe) and boron (B) and composed stoichiometrically according to R₂Fe₁₄B, wherein R includes the elements neodymium (Nd), praseodymium (Pr), cerium (Ce), lanthanum (La) and/or yttrium (Y), and wherein cerium is at least 50% of R.

18. The rotor of claim 17, wherein the magnets have a biconvex lens-shaped and/or plano-convex lens-shaped and/or concave-convex lens-shaped configuration.

19. The rotor of claim 17, wherein the magnets have a shape deviation on an air gap side.

20. The rotor of claim 19, wherein the shape deviation is embodied as a linear depression with a rounded and/or flat base.

21. The rotor of claim 19, wherein the shape deviation is embodied as a groove and/or corrugation circumferentially on an external periphery of the rotor.

22. The rotor of claim 17, further comprising a binding on an external periphery of the rotor.

23. The rotor of claim 22, wherein the magnets have a shape deviation on an air gap side, said binding being a thread binding including a binding thread arranged in a depression of the shape deviation.

24. A dynamoelectric machine, comprising the rotor of claim 17.

25. The dynamoelectric machine of claim 24, wherein the magnets have a biconvex lens-shaped and/or plano-convex lens-shaped and/or concave-convex lens-shaped configuration.

26. The dynamoelectric machine of claim 24, wherein the magnets have a shape deviation on an air gap side.

27. The dynamoelectric machine of claim 26, wherein the shape deviation is embodied as a linear depression with a rounded and/or flat base.

28. The dynamoelectric machine of claim 26, wherein the shape deviation is embodied as a groove and/or corrugation circumferentially on an external periphery of the rotor.

29. The dynamoelectric machine of claim 25, further comprising a binding on an external periphery of the rotor.

30. The dynamoelectric machine of claim 29, wherein the magnets have a shape deviation on an air gap side, said binding being a thread binding including a binding thread arranged in a depression of the shape deviation.

31. A method for manufacturing the rotor of claim 17, the method comprising:
carrying out a feedstock production to manufacture a metal powder-binder mixture which has cerium in powder form; and
manufacturing the magnets by metal injection molding.

32. The method of claim 31, further comprising:
debinding the magnets; and
sintering the magnets.

33. The method of claim 31, further comprising using recycling material for the feedstock production.

34. The method of claim 33, further comprising using neodymium, iron and/or boron obtained from the recycling material for the feedstock production.
